(19) United States
(12) Patent Application Publication
(10) Pub. No.: US 2011/0126412 A1
(43) Pub. Date: Jun. 2, 2011

(54) Hair Removal Apparatus

(76) Inventors: Xavier Perez-Lopez, Eschborn (DE); Andreas Larscheid, Kelkheim (DE)

(21) Appl. No.: 12/522,283

(22) PCT Filed: Jan. 29, 2008
(86) PCT No.: PCT/EP2008/000652

§ 371 Date: Jan. 6, 2010

(30) Foreign Application Priority Data
Feb. 1, 2007 (DE) 10 2007 005 853.7

(51) Int. Cl. B26B 19/26

(52) U.S. Cl. 30/34.1

(57) ABSTRACT

The invention relates to a hair removal apparatus having a housing (1) which holds a drive motor (2) for at least one first cutting system designed as a trimmer (4). The trimmer (4) has at least two cutting parts (7, 8), each having at least two rows of teeth that are drivable relative to one another. The hair removal apparatus has at least one other second cutting system, which has at least one sharp-edged razor blade (22). The second cutting system is arranged on a carrier element (19) which is movably guided on the housing (1). The carrying element (19) is adjustable in at least two different positions by a corresponding switching movement by the user. The trimmer (4) is always connected to the drive motor (2).

The invention relates to a hair removal apparatus according to the preamble of patent claim 1.

Such a hair removal apparatus is known, for example, from WO 2005/102623 A2; this document discloses an essentially known wet shaver on which an electrically drivable trimmer is also mounted. This trimmer is displaceably or pivotably mounted on the handle of the wet shaver and its movable trimmer blade is provided with a coupling device, which engages in a section of the electric drive after displacement or pivoting relative to the handle of the wet shaver, thereby starting operation of the trimmer arrangement. When the trimmer is moved back out of this use position into the parked position, the movable trimmer blade is again released from the electric drive, so that it no longer executes a movement relative to the stationary trimmer blade.

This position-dependent coupling and/or uncoupling of the trimmer device with the electric drive represents a not insignificant complexity as well as a possible source of error for the cutting system. However, this fundamental problem is further reinforced by the fact that during operation, the hair removal apparatus is also constantly exposed to water, shaving cream and the beard stubble contained therein.

The object of the invention is therefore to create a hair removal apparatus of the aforementioned type, characterized by an especially simple construction designed for a long and safe use such that the hair removal apparatus can also be manufactured especially easily and inexpensively.

This object is achieved according to the invention by the characterizing features of claim 1.

The inventive approach allows the use of the electrically driven trimmer without prior movement of same into a coupling position with the electric drive. Through the inventive approach, it is possible to reduce the number of necessary components, in particular the components movable relative to one another. The carrying element is advantageously displaceably guided on the housing, such that the displacement may follow a linear and/or curved path. This allows simple positioning by the user, so that positioning in different operating positions can be further simplified by corresponding catch elements arranged along the displacement path. Alternatively or additionally, a pivotable support of the carrying element on the housing is also possible, thereby creating additional design options for positioning the second cutting system.

According to an especially simple embodiment of the invention, the trimmer is arranged in a stationary position on the housing. However, to increase comfort in shaving and/or with respect to a better adaptation of the trimmer to the contour of the skin surface to be shaved, it is advantageous if the trimmer has a floating mount on the housing. Such an embodiment allows the trimmer to yield as a function of the contact pressure applied by the user against an elastic pretension of the trimmer.

If the tips of the teeth in the rows of trimmer teeth are aligned essentially in the same direction as the cutting edge of the razor blade, then simultaneous use of the two cutting systems is made possible. The trimmer is arranged here so that it lies in front of the cutting edge of the razor blade, as seen in the direction in which the shaver is pulled, so that a rough shave and/or preshortening of hair is accomplished by trimmer, and the razor blade completes the shaving of the remaining hair.

To also permit optimum adaptation of the second cutting system to the contour of the skin to be shaved, another advantageous embodiment of the invention provides for the second cutting system to be pivotably and/or floatingly mounted on the carrying element.

An optimized embodiment of the invention with regard to thorough shaving in particular provides for the second cutting system to have multiple razor blades arranged on a common carrier. This essentially known multiblade arrangement produces a more thorough shaving with the same number of strokes of the shaver.

In conjunction with a spacer comb provided for the trimmer and known essentially from WO 00/37225 A1 for example, the inventive hair removal apparatus may be used not only for shaving but also for trimming hair to a preselected length. One embodiment of the invention is therefore provided with a fastening option for such a spacer comb. A certain distance between the trimmer and the skin to be shaved is set by means of the spacer comb. This distance then determines the length of the hair remaining. The spacer comb may be designed to be adjustable in an essentially known manner, so the user can adjust different distances with a single spacer comb and can thus adjust different remaining hair lengths. However, it is also possible to adjust the remaining hair length by selecting a spacer comb of the desired length from a set of spacer combs of different lengths and then attach it to the housing of the hair removal apparatus. The second cutting system is advantageously completely covered by the spacer comb, thus prevented unwanted shortening of the hair by this second system.

Additional goals, features and possible applications of the present invention are derived from the following description of an exemplary embodiment. All the features described or illustrated graphically here, either alone or in any combination, constitute the subject of the present invention, even independently of how they are combined in their claims or their reference back to previous claims.

In the drawings:

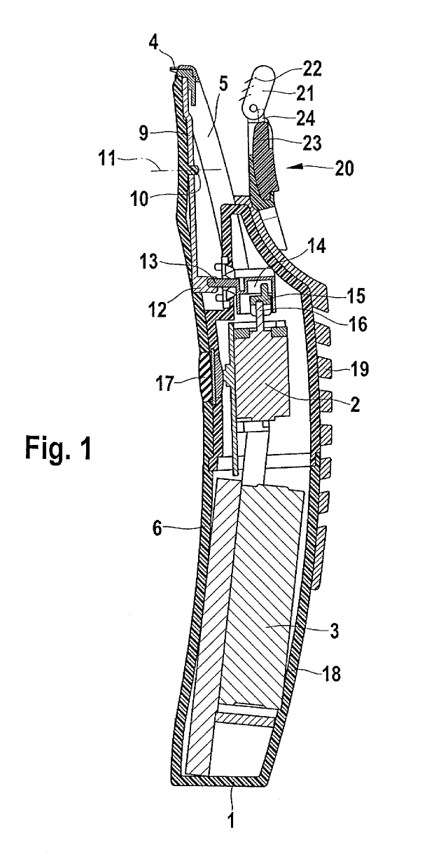

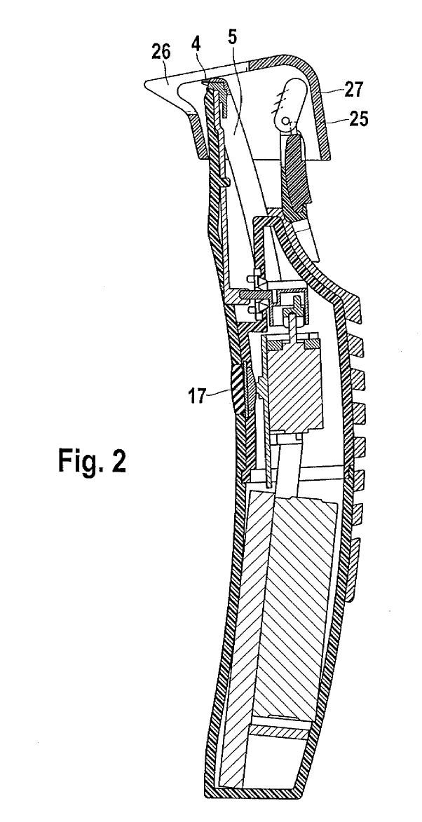

FIG. 1 and FIG. 2 each show a section through an inventive hair removal apparatus, where the carrying element of the second cutting system is in the inserted position,

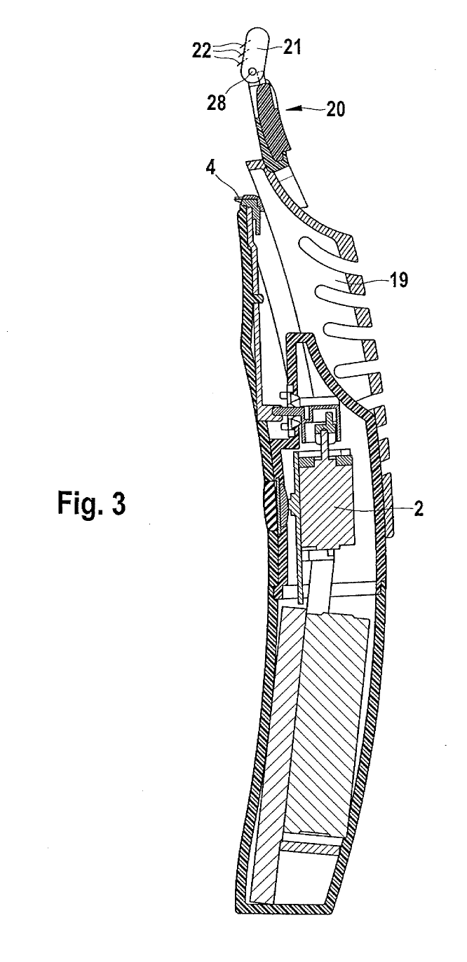

FIG. 3 shows a similar section in which the carrying element is in its maximally extracted position,

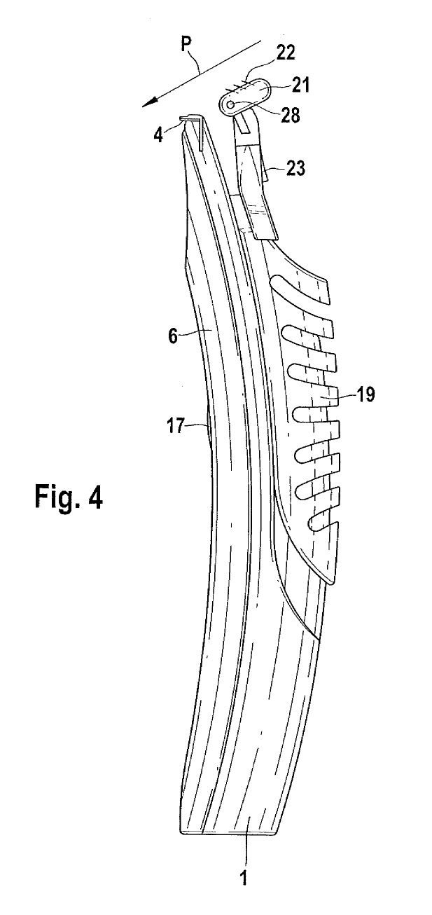

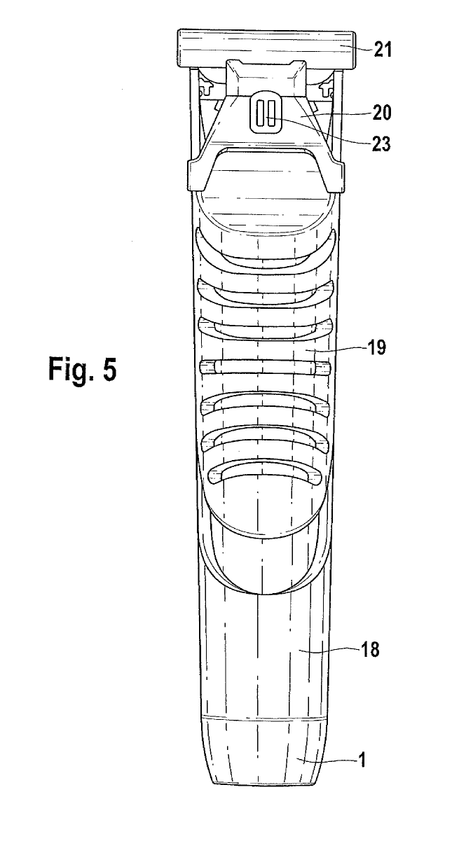

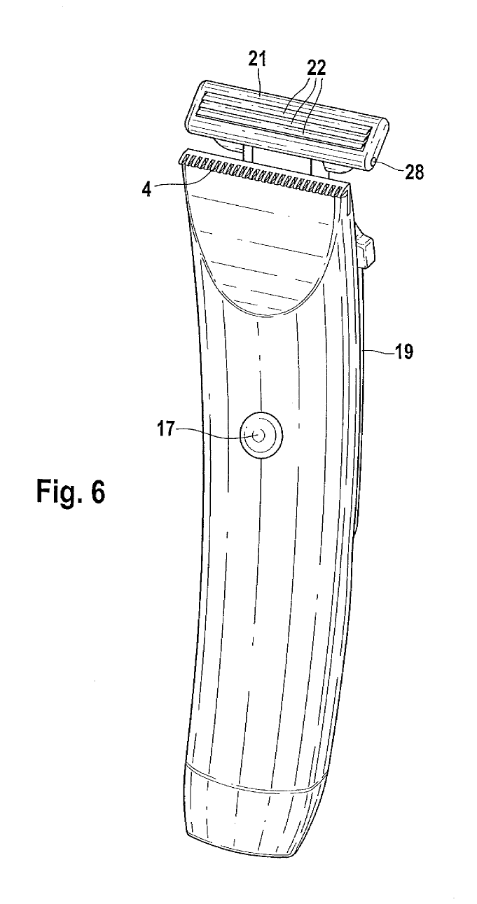

FIGS. 4 to 6 show side views from the rear and a perspective view of an inventive hair removal apparatus in which the carrying element with the second cutting system is in a middle operating position, and

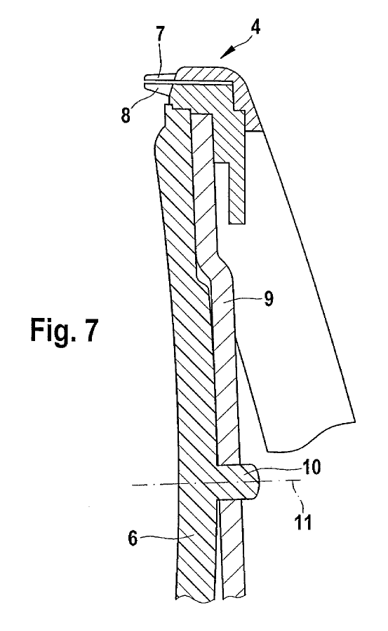

FIG. 7 shows the trimmer according to FIG. 1 in an enlarged diagram.

The hair removal apparatus shown in a side view of a section in FIG. 1 has a housing 1, which holds an electric motor 2 and an electric energy storage mechanism embodied as an electric battery 3. A trimmer 4 is arranged on the upper end section 5 of the housing 1, having an elongated design, its cutting elements pointing in the direction of the front side 6 of the housing. FIG. 7 shows the trimmer, which has an essentially known design, on an enlarged scale. The trimmer 4 comprises a stationary trimmer comb 7 and a driven trimmer blade 8, with the trimmer blade 8 arranged beneath the trimmer comb. Both the trimmer comb 7 and the trimmer blade 8 are designed in the shape of a comb having a plurality of prongs arranged one after the other in rows, with the prongs being aligned toward the left according to the figure, i.e., in the direction of the front side 6 of the housing. Whereas the trimmer comb 7 is fixedly mounted on the housing, the trimmer blade 8 running parallel to it is attached to the end of a rocker arm 9 mounted to pivot about a rotary bearing 10 that defines a rotational axis 11 on the inside of the housing front part 6. On the end of the rocker arm 9 opposite the trimmer blade 8, a tappet 12 is formed, engaging with the drive pin 13 formed on a swing bridge 14 (see FIG. 1). The cam 15 arranged on the drive shaft 16 of the electric motor 2 that can be driven to rotate engages in this swing bridge 14. From the rotational movement of the drive shaft 16, the swing bridge 14 produces a linear oscillating movement at a right angle to the plane of the drawing. An on/off switch 17 provided in the front part 6 of the housing serves to connect the electric motor 2 to the electric power supply of the battery 3 and disconnect it therefrom, respectively. When the electric motor 2 is turned on, the rotary drive shaft 16 in combination with the cam 15 generates the oscillating movement of the swing bridge 14, which is transmitted via the drive pin 13 to the tappet 12 on the rocker arm 9. This in turn leads to an oscillating pivoting movement of the rocker arm 9 about the rotational axis 11 and thus leads to an oscillating displacement of the trimmer blade 8 relative to the trimmer comb 7, so that hair passing between the prongs of this cutting system is cut off.

A carrying element designed as a slide 19 is arranged on the back side 18 of the housing so it is vertically displaceable. To this end, guides (not shown in the drawing) are arranged on these parts. FIG. 1 shows the slide 19 in its lower end position. A receptacle 20 for a blade carrier 21 is arranged on the upper end of the slide 19. The receptacle 20 allows the attachment and release of the blade carrier 21, on which several sharp-edged razor blades 22 are arranged. The receptacle 20 has a release button 23 with a tappet 24 directed upward. To release the blade carrier 21 that has engaged in the receptacle 20, the release button 23 is moved upward, so that the tappet 24 acts upon the blade carrier 21 and pushes it out of the receptacle 20.

The operating position of the slide 19 and/or the razor blades 22 shown in FIG. 1 represents a parked position, so to speak, for the second cutting system in which the razor blades 22 are protected behind the upper end section 5 of the housing 1. In this parked position, only the trimmer 4 may be used for trimming or removing hair.

FIG. 2 shows the inventive hair removal apparatus with razor blades in the parked position, i.e., as already shown in FIG. 1, but with a spacer comb 25 placed on the upper end section 5. The spacer comb defines a minimum distance between the trimmer 4 and the hair to be shaved in a known way, resulting in the hair being trimmed only to a certain extent when the trimmer 4 is used with the spacer comb 25 attached, but a completely smooth shave is no longer possible. Hair to be trimmed is passed through slots 26 to the trimmer 4, the slots running parallel to the extent of the prongs of the trimmer comb 7 and/or the trimmer blade 8 and being arranged in the forward part of the spacer comb 25. The rear part 27 of the spacer comb 25 can cover the razor blades 22 and the blade carrier 21, so that they cannot come in contact with the hair on the skin surface to be treated.

FIG. 3 shows the hair removal apparatus in an operating state in which the slide 19 is in its maximally extracted position, i.e., extracted completely toward the front. This position of the slide 19 is then set by the user when he wants to use only the second cutting system, i.e., the razor blades 22 for a (wet) shave. In this highly extracted position, the second cutting system is so far away from the trimmer 4 that no more risk can emanate from it with respect to inadvertent scratching of the skin while using the razor blades 22. Through appropriate electrical or mechanical means (which are not shown in the drawing here), it is possible to ensure that in the maximally extracted position of the slide 19, it is no longer possible to turn on the electric motor 2. For the best possible adaptation of the razor blades 22 to the contour of the skin to shaved, the blade carrier 21 is mounted to pivot about a pivot axis 28 on the slide 19 and/or on the receptacle 20.

FIGS. 4 to 6 show the inventive hair removal apparatus in a switch state of the slide 19 in a middle displacement position, which allows simultaneous use of both the trimmer 4 and the razor blades 22 for a so-called “combination shave.” If the hair removal apparatus is now pulled according to the arrow P over the skin surface to be shaved with the side 19 in the switch position illustrated in FIG. 4, then the hair present there is first trimmed by the trimmer 4 and the remaining hair is then thoroughly shaved off by the razor blades 22 during the same stroke.

What is claimed is:

1. A hair removal apparatus having a housing (1), which holds a drive motor (2) for at least one first cutting system designed as a trimmer (4), whereby the trimmer (4) has at least two cutting parts (7, 8) that have rows of teeth and can each be driven relative to one another, and having at least one other second cutting system which has at least one sharp-edged razor blade (22), characterized in that the second cutting system is arranged on a carrying element (19) which is movably guided on the housing (1) and is adjustable by a corresponding switching movement by the user into at least two different positions, said trimmer always being connected to the drive motor (2).

2. The device according to claim 1, characterized in that the carrying element (19) is guided displaceably on the housing (1).

3. The device according to any one of the preceding claims, characterized in that the carrying element (19) is mounted pivotably on the housing.

4. The device according to any one of the preceding claims, characterized in that the trimmer (4) is arranged in a stationary position on the housing (1).

5. The device according to any one of claims 1 to 3, characterized in that the trimmer (4) is in a floating mount on the housing (1).

6. The device according to any one of the preceding claims, characterized in that the tips of the teeth of the rows of teeth are aligned in essentially the same direction as the edge of the at least one razor blade (22).

7. The device according to any one of the preceding claims, characterized in that the second cutting system is pivotably and/or floatingly mounted on the carrying element (19).

8. The device according to any one of the preceding claims, characterized in that the second cutting system has multiple razor blades (22) which are arranged on a common carrier (21).

9. The device according to any one of the preceding claims, characterized in that the housing (1) has a fastening option for a spacer comb (25) which is provided for the trimmer (4).

10. The device according to any one of the preceding claims, characterized in that the second cutting system can be covered by the spacer comb (25).
